(19) United States
(12) Patent Application Publication
(10) Pub. No.: US 2026/0211637 A1
(43) Pub. Date: Jul. 23, 2026

(54) PROCESS ANALYSIS AND AUTOMATION THROUGH MACHINE LEARNING PROCESSING OF NETWORK DATA

(71) Applicant: INTERNATIONAL BUSINESS MACHINES CORPORATION, ARMONK, NY (US)

(72) Inventors: Vinicius Maidana Alves, São José do Rio Preto (BR); Gabriel Duarte Sanchez, São José do Rio Preto (BR); Lucas Lima Oliveira, Sao Paulo (BR); Pedrenrique Goncalves Guimaraes, São José do Rio Preto (BR)

(21) Appl. No.: 19/034,500

(22) Filed: Jan. 22, 2025

(51) Int. Cl. G06F 8/35; G06F 8/41

(52) U.S. Cl. CPC G06F 8/35; G06F 8/427

(57) ABSTRACT

Automated generation of scripts includes receiving by a script generation engine, a user input prompt for a task and packages associated with the task, via a user interface. A machine learning engine parses the prompt into words representing a process associated with the task. The machine learning engine determines context from the words related to the task and associate the context with the packages. The machine learning engine identifies one or more sections of packages with context that are dynamic values within the process as potential variables. The script generation engine queries a retrieval of stored packages associated with the task. The machine learning engine replaces the dynamic values with a variable. The script generation engine generates a script configured to perform the task, wherein the script includes the variable as a placeholder for a user entry of the dynamic values.

### BACKGROUND

### Technical Field

The present disclosure generally relates to information and communication technology, and more particularly, to process analysis and automation through machine learning processing of network data.

### Description of the Related Art

Users commonly engage with computerized user interfaces to complete repetitive tasks. Repetitive tasks can consume an inordinate amount of user time for tasks that are simple and mundane but require multiple steps to complete.

One approach seeks to automate repetitive computer tasks by recording a user’s actions through a UI-based recorder. A UI (user interface) recorder is an automation tool that records interactions with graphical user interfaces as an automated test script. It enables video-like capture of manual test cases by tracking mouse movements, clicks, keyboard inputs and other UI actions. UI-based recorders rely mostly on the user interfaces themselves and interactions therewith. When there are changes to values involved, such changes are not usually accounted for in a previously recorded interaction and need extra steps to make a task run without issues.

### SUMMARY

According to an embodiment of the present disclosure, a computer program product for automated generation of scripts is disclosed. The computer program product comprises a computer readable storage medium having program instructions embodied therewith. An execution of the program instructions causes a processor to receive, by a script generation engine, a user input prompt for a task and packages associated with the task, via a user interface. A machine learning engine parses the prompt into words representing a process associated with the task. The machine learning engine determines context from the words related to the task and associate the context with the packages. The machine learning engine identifies one or more sections of packages with context that are dynamic values within the process as potential variables. The script generation engine queries a retrieval of stored packages associated with the task. The machine learning engine replaces the dynamic values with a variable. The script generation engine generates a script configured to perform the task, wherein the script includes the variable as a placeholder for a user entry of the dynamic values.

According to an embodiment of the present disclosure, a method for automated generation of scripts is disclosed. The method includes receiving by a script generation engine, a user input prompt for a task and packages associated with the task, via a user interface. A machine learning engine parses the prompt into words representing a process associated with the task. The machine learning engine determines context from the words related to the task and associate the context with the packages. The machine learning engine identifies one or more sections of packages with context that are dynamic values within the process as potential variables. The script generation engine queries a retrieval of stored packages associated with the task. The machine learning engine replaces the dynamic values with a variable. The script generation engine generates a script configured to perform the task, wherein the script includes the variable as a placeholder for a user entry of the dynamic values.

According to an embodiment of the present disclosure, a computing device includes a processor operating a user interface. Memory is coupled to the processor. The memory stores instructions causing the processor to perform acts including receiving by a script generation engine, a user input prompt for a task and packages associated with the task, via a user interface. A machine learning engine parses the prompt into words representing a process associated with the task. The machine learning engine determines context from the words related to the task and associate the context with the packages. The machine learning engine identifies one or more sections of packages with context that are dynamic values within the process as potential variables. The script generation engine queries a retrieval of stored packages associated with the task. The machine learning engine replaces the dynamic values with a variable. The script generation engine generates a script configured to perform the task, wherein the script includes the variable as a placeholder for a user entry of the dynamic values.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block diagram of a computing environment for automated generation of scripts, consistent with an illustrative embodiment.

FIG. 2 is a block diagram of an architecture for automated generation of scripts, consistent with an illustrative embodiment.

FIG. 3 is a block diagram of a script generation engine architecture, according to an embodiment.

FIG. 4 is a flowchart of a method for automated generation of scripts, consistent with embodiments.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

### Definitions

Module, as used herein, refers to a software application, which may be standalone or may be a hardware component that includes the software application programmed in to memory or a circuit.

Artificial intelligence (A.I.), as used herein, refers to computer systems, and sometimes their software, capable of performing complex tasks that historically only a human could do, such as reasoning, making decisions, or solving problems.

Machine Learning, as used herein, refers to a branch of artificial intelligence (A.I.) and computer science that focuses on using data and algorithms to enable A.I. to imitate the way that humans learn, gradually improving its accuracy.

Large Language Model, as used herein, refers to a category of foundation models trained on immense amounts of data making them capable of understanding and generating natural language and other types of content to perform a wide range of tasks.

Intent, as used herein, refers to understanding how actions performed by a person’s interaction with data may indicate some underlying concept or purpose.

Data Packages, as used herein, refers to words extracted from network packets that have been processed and associated with some task action.

Embedding, as used herein, refers to a method of translating text (e.g., structured network data) into a vector of floating-point numbers. These vectors are stored in a vector database to enable semantic searches, where similar queries retrieve contextually or semantically related results

Dynamic Value or Variable, as used herein, refers to any section or piece of a process whose underlying data can change from one instance to another instance. In computer programming, variables refer to a named storage location that holds a value or data, essential in computer programs as a basic building block of a program. These values can change during the execution of a program, hence the term “variable” and “dynamic value.” For example, a token generated during a login process is stored in a variable and passed as an authentication parameter in subsequent steps. The key concept here is that this token changes depending on the user, so instead of using all possible values, one could just store the in-the-moment value in a variable and reference said variable. Large Language Models (LLMs) excel at identifying these dynamic values within structured or standard formats like text.

High-level language, as used herein, refers to programming languages, such as JavaScript, Python, and Go, designed to abstract low-level machine language and to provide user-friendly syntax for efficient programming. These types of languages are often used in scripting and automation tasks.

Intermediate level language, as used herein, refers to structured data formats, such as CSV or XML, used to represent user actions or events. These data formats can be parsed for analysis or transformed into inputs for automation tools or other systems.

### Overview

The present disclosure generally relates to automating scripts for tasks. Automating repetitive tasks often requires interacting with UI elements that are unreliable and often times can’t differentiate static data from dynamic data. At the same time, networking data provides a reliable source of data, but networking data can be difficult for human workers to interpret. A system that can interpret networking data and work with human input to accomplish an automation task is a viable alternative to traditional robotic process automation methods. The subject technology presented herein uses an A.I. powered by, for example, an LLM to parse network data and a user prompt to accurately capture meaningful actions from the network data, and produce a script in a high-level language or an intermediate language that performs the automation task at hand.

The subject technology includes system that uses artificial intelligence (A.I.) powered by machine learning (for example, a large language model (LLM)) to parse a user-provided end-to-end description of a process and network traffic data packages to create automation scripts, automatically identifying variables in the requested process. The human user describes the process in a prompt, and the system uses an LLM to parse the prompt to perform the task by cross-referencing data packages from multiple sources. For example, if the user prompt mentions logging into an application, the system understands that it needs to identify the packages related to logging into the application, thus creating the script and the variables needed for the process. The system outputs network file data into an intermediate data exchange format such as CSV or JSON, and outputs the automation script in the programming language chosen by the user.

A.I. is leveraged to synthesize network data into an automation script by using a prompt provided by a human user describing a process. A collection of network traffic packages describes the end-to-end process performed by humans. The system may use a LLM to parse the network traffic packages and correlate the network data with the process description, creating an end-to-end process with network traffic packages. Dynamic values may be identified from the network activity by cross referencing data from multiple packages with the process description, and automatically generating variables for these values. A dynamic value within captured data is represented by any user-input or system-generated data that can change on a given moment of the process. This moment can be at any step of the process, for example, the user credentials when logging into applications might differ depending on the user; the same for the token generated for that user. In the subject technology, recording a complete reproduction of the same steps the user performed in a script would have little value for other users since the dynamic values in the process would be different and would provide an unsuccessful login result. The script would require individual values for every user to be effective. Not only that, but the systems the user interacts with will output data that needs to be captured and, in turn, used in subsequent steps.

In the subject technology, every performance of an operation by a user needs data to flow from one instruction to the other, and that data that can be different from one instance to the next is placed in a variable value. Since this data can change between executions, the variable value is considered dynamic. The LLM of the subject technology can distinguish between static data values (those which remain constant between instances) and variable values by using the user prompt and the stored knowledge the LLM has built up. An example of a value that would not be a dynamic variable (i.e. a static value) is a website address whose input must be the same between every user to access and land on the same page; thus, the web address is considered a constant value between instances because the underlying data remains the same between instances of use. When generating the automation script, instead of using hardcoded values, the script generation module may append these variables to the script where dynamic input and output values should be.

As will be appreciated, while many of the elements in the subject technology are software-based, the processes involved provide an improvement to user interfaces using computing technology; namely by automating the generation of scripts for computer tasks that a user plans on using repetitively. This, in and of itself, is an improvement in how computers are operated, and thus is an improvement in computer technology. In addition, the detection features in the subject technology identify engagement network data segments and use artificial intelligence to learn a user’s intent from that engagement. The A.I. generates dynamic variables from the intent and prompt, which can be used to identify stored packages that will provide the intended desired result in a script. Accordingly, the embodiments herein provide technology that is both useful and an improvement over the state of the art in user interfaces and data presentation.

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may obviate a need for time consuming data processing by the user. This may have the technical effect of reducing computing resources used by one or more devices within the system. Examples of such computing resources include, without limitation, processor cycles, network traffic, memory usage, storage space, and power consumption.

It should be appreciated that aspects of the teachings herein are beyond the capability of a human mind when considering that the process analyzes the behavior of multiple users who each have individual thought processes when it comes to analyzing the same data set. It should also be appreciated that the various embodiments of the subject disclosure described herein can include information that is impossible to obtain manually by an entity, such as a human user. For example, the type, amount, and/or variety of information that can be part of the process when performed in an enterprise setting included in performing the process discussed herein can be more complex than information that could be reasonably be processed manually by a human user.

### Example Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one or more storage devices that may include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

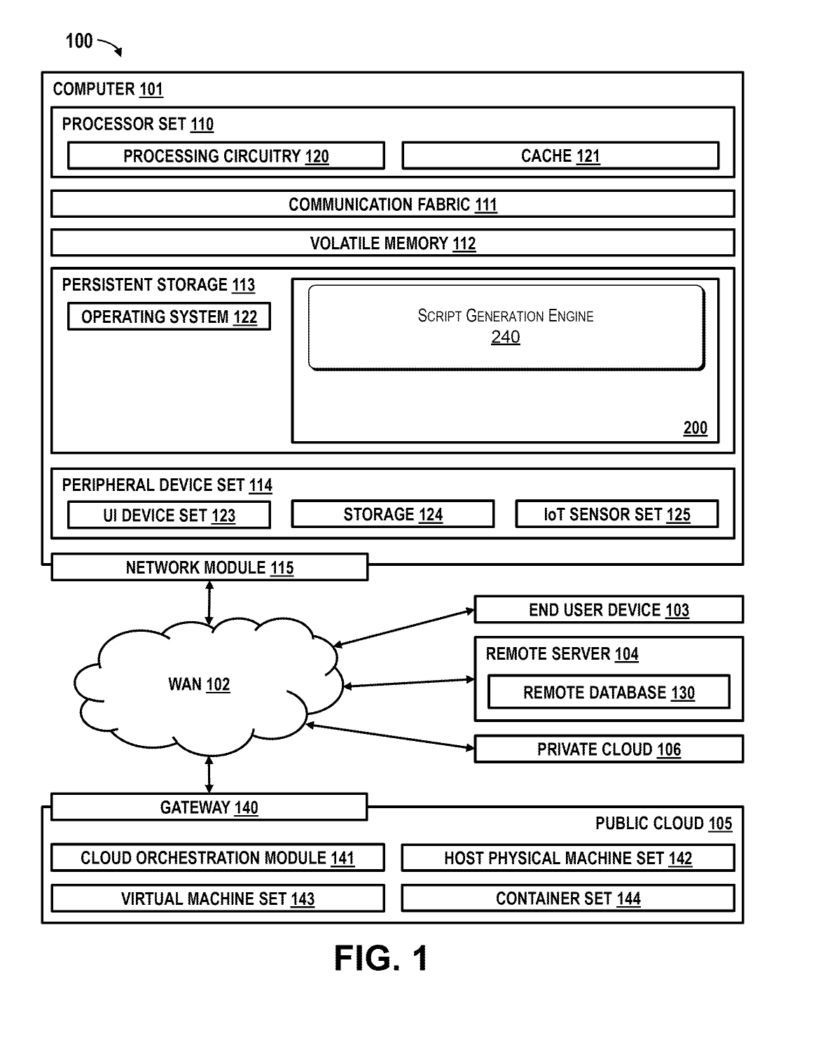

Computing environment 100 of FIG. 1 includes an example of an environment for the execution of at least some of the computer code involved in performing the inventive methods, such as the improved script generating code 200. The improved script generating code 200 may include a script generation engine 240 that automatically generates scripts to perform a task in response to a user input prompt. The script generation engine 240 may operate according to one or more of the methods disclosed in further detail below. In addition to script generating code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and script generating code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. For the instant disclosure, the processor set 110 includes for example a central processing unit (CPU) and an accelerator. In some embodiments, a different type of processing element may be used instead of the CPU, (for example, a GPU or other process dedicated/specialized unit). Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in script generating code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in script generating code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example System Architecture

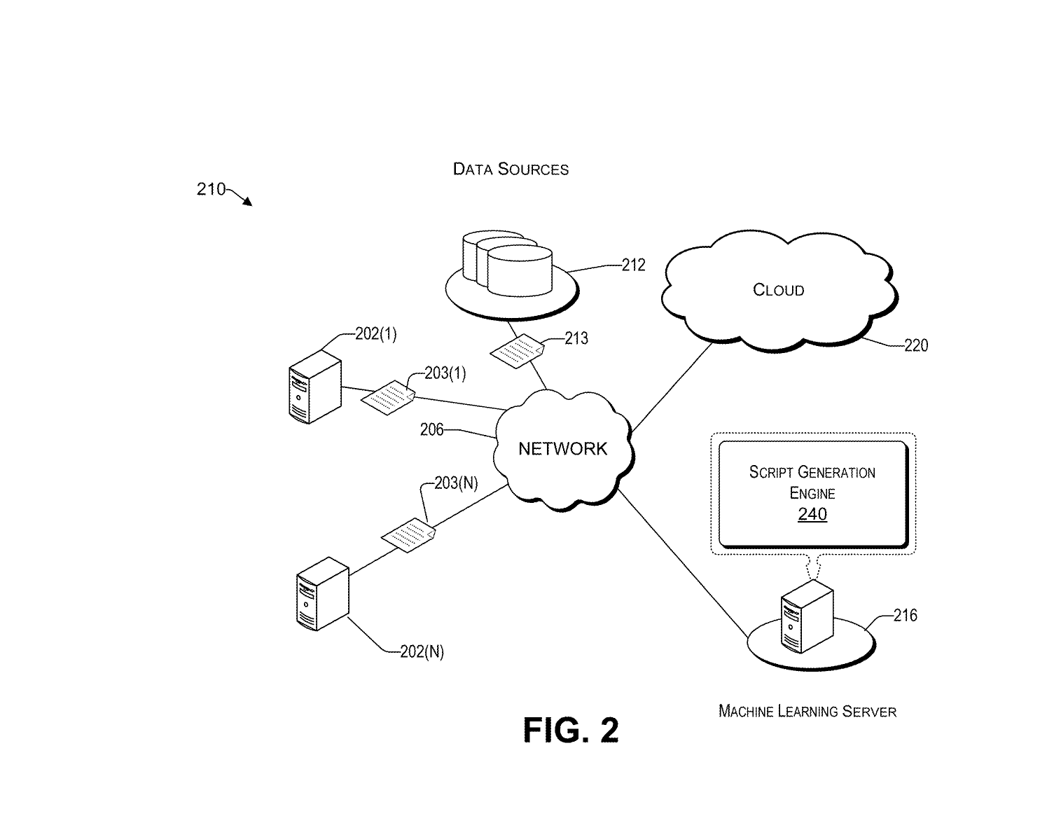

FIG. 2 illustrates an example architecture 210 for automated script generation. Architecture 210 includes a network 206 that allows various computing devices 202(1) to 202(N) to communicate with each other, as well as other elements that are connected to the network 206, such as data source 212, a machine learning server 216, and the cloud 220. The computing devices 202(1) to 202(N) and machine learning server 216 may operate under the computing environment described above in FIG. 1. The machine learning server 216 may operate the script generating code 200, including the script generation engine 240.

Generally, when a user opens a software module for script generation, such as a user interface operating the script generating code 200, the user may initiate and communicate with the script generation engine 240 through the user interface connected to the network 206. The user may provide a prompt into the user interface which is interpreted by the script generation engine 240 to create a script for a computer operated activity. The script generation engine 240 may then communicate with one or more other elements in the architecture 210 to generate the requested script.

The network 206 may be, without limitation, a local area network (“LAN”), a virtual private network (“VPN”), a cellular network, the Internet, or a combination thereof. For example, the network 206 may include a mobile network that is communicatively coupled to a private network, sometimes referred to as an intranet that provides various ancillary services, such as communication with various application stores, libraries, and the Internet. The network 206 allows the script generation engine 240, which is a software program running on machine learning server 216, to communicate with the data source 212, computing devices 202(1) to 202(N), and/or the cloud 220, to provide data processing. The data source 212 may include datasets associated with stored packages of tasks and language libraries, that will be processed under one or more techniques described here. In some embodiments, a data packet 213 may be received by script generation engine 240 that includes a prompt and/or words that are parsed from the prompt. This data packet 213 can be received by the script generation engine 240 by either a push operation from the data source 212 or from a pull operation of the script generation engine 240. In one embodiment, the data processing for the script generation engine 240 is performed at least in part on the cloud 220.

For purposes of later discussion, several user devices appear in the drawing, to represent some examples of the computing devices that may be the source of data being analyzed depending on the task chosen. Aspects of the symbolic sequence data (e.g., 203(1) and 203(N)) may be communicated over the network 206 with the script generation engine 240. Today, user devices typically take the form of desktop computers, portable handsets, smart-phones, tablet computers, personal digital assistants (PDAs), and smart watches, although they may be implemented in other form factors, including consumer, and business electronic devices. While the data source 212 and the script generation engine 240 are illustrated by way of example to be on different platforms, it will be understood that in various embodiments, the data source 212 and the machine learning server 216 may be combined. In other embodiments, these computing platforms may be implemented by virtual computing devices in the form of virtual machines or software containers that are hosted in a cloud 220, thereby providing an elastic architecture for processing and storage.

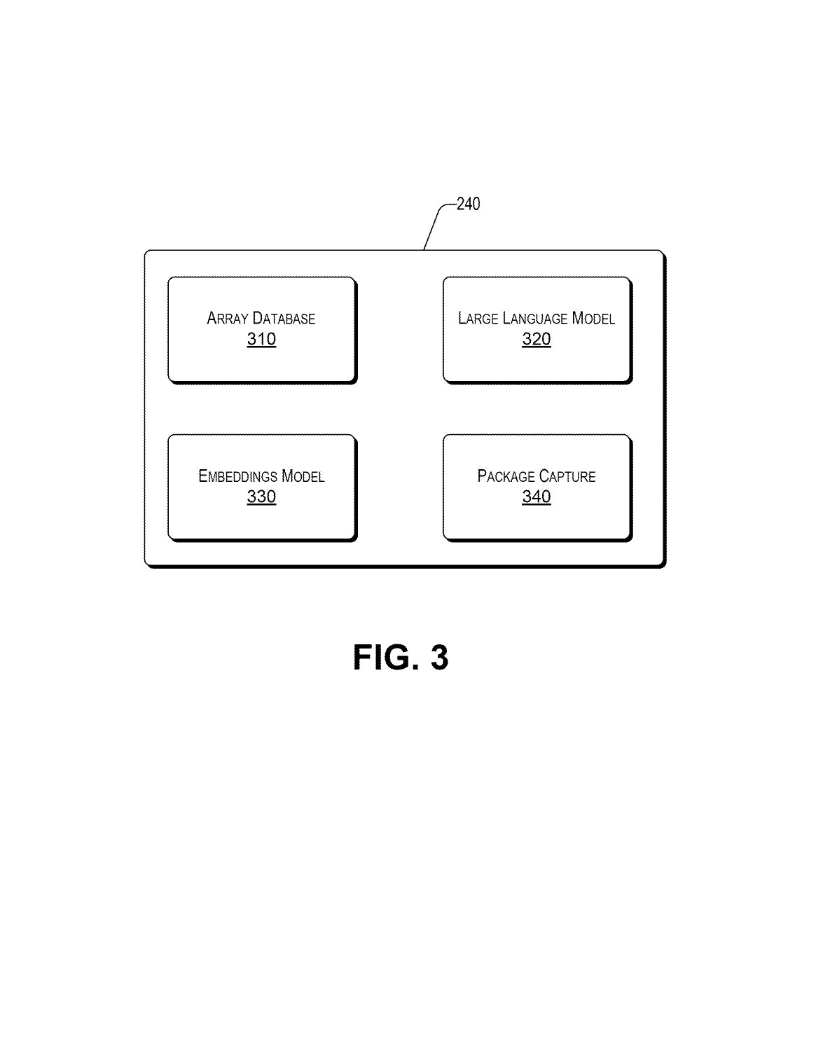

FIG. 3 shows an embodiment of the script generation engine 240. The script generation engine 240 may include sub-component modules. In one example, the script generation engine 240 includes an array database 310, a large language model 320, an embeddings model 330, and a package capture module 340.

The array database 310 may be configured to store requests and context based on HAR (HTTP Archive) files. The array database 310 enables the system to retrieve relevant packages and context for each user prompt.

The Large Language Model 320 may be configured to break down user prompts into action steps to accomplish a task, and to enrich the packages with context description of what the package does. During the script generation process, inferences over the user prompt and the context-driven packages may set the Large Language Model 320 to identify user input as dynamic values in the context-driven package, thus identifying them to be replaced by variables in the final script. The LLM 320 may utilize embeddings to find matching packages in the array database 310.The embeddings model 330 may be configured to transform text into a format that can be used for associations. In some embodiments the text is transformed into float arrays to enable similarity-based searching. This embeddings model 330 enables the system to find relevant packages in the array database 310 using associations relevant to the prompt goals.

The package capture module 340 may be configured to capture network traffic data. The package capture module 340 stores network traffic packages. The network traffic packages include one or more JSON object entries describing the HTTP request made to a system, including their inputs and outputs. When provided to the end user, the package is in HTTP Archive (HAR) format.

### Example Methodology

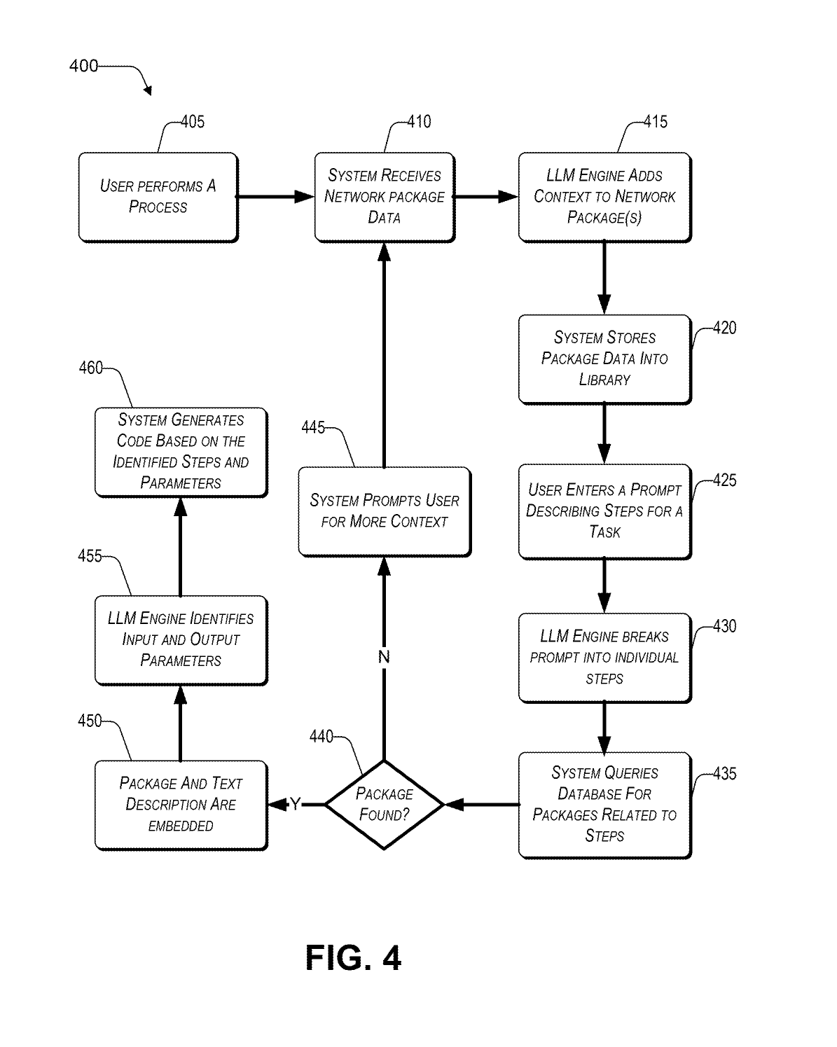

FIG. 4 shows a method 400 of automated script generation according to an illustrative embodiment. The script generation engine 240 performs the steps outlined in Method 400 to generate scripts based on user prompts and network traffic package enrichment.

### Set-up Phase

In block 405, a user performs a process, generating network traffic related to the process. In block 410, the package capture model 340 receives network package data from the network traffic related to the process. In block 415, the Large Language Model 320 engine parses the network data into words and word combinations associated with computer actions. The engine records the user's input activity and sends the data to a modelling module that refines learning of words and actions from the user's input. Underlying processes using repetitive entry of data between instances (e.g., registration, login, data entry tasks, etc.) are identified from the user's activity as potential variables. The network data recorded during identified performance of underlying processes is assembled as groups of data packages, with their descriptions and potential variables. Data packages are recorded with tags associating the data with one or more tasks. In block 420, the engine adds context to network data packages, which will aid in associations. Context is learned from previous user engagement with a process or specific task along with the user prompt. The system stores package data, including associations and context data, into a library (e.g., into data sources 212 of FIG. 2 and/or array database 310 of FIG. 3).

### Script Generation Phase

In block 425, a User describes the process to Large Language Model 320 engine through a user prompt in the user interface, generating high-level context to the process. The request may be implied as the user enters steps describing a task to be performed, without necessarily having to affirmatively request the generation of a script. In block 430, the Large Language Model 320 engine breaks the prompt down into individual steps of the process. A task(s) to be performed (the process) is identified from the steps. In block 435, the script generation engine 240 queries the array database 310 for one or more data packages related to the steps identified by the LLM model 320. In block 440, a determination is performed as to whether one or more data packages related to the task request are found. If not, the user is prompted for more context. In block 445, the additional context is added to the library of packages by repeating blocks 410, 415, and 420. The user prompted data entered at block 425 is re-referenced by the script generation engine 240, along with the additional context provided by the user, re-initiating the breakdown of the prompt at block 430. In block 450, in response to a data package being located in the array database 310, the data package and text description are embedded into the output for the task being performed by the user, generating embedded steps. In block 455, the Large Language Model 320 engine identifies input and output parameters for the task request out of the embedded steps. In block 460, the script generation engine 240 generates code (for example, a script) based on the embedded steps, using the input and output parameters, that associate the process steps with context-described packages. The Large Language Model 320 uses the process steps with context-described packages to generate code or data entry output for the task requested. The output may be provided to the requesting user as a stored script that is invokable for the task. The output may include sections represented by one or more variable placeholders where the end user may modify with dynamic data related to the current instance of the process being performed.

### Example Use Case

User Prompt: "Every day, I log into our intranet system, then I click on 'unpaid invoices'. This gets me a list of unpaid invoices, and I download each one of them by clicking on the download button."

### Broken Down Steps

User logs into intranet system.

User clicks on 'unpaid invoices'.

User sees a list of unpaid invoices.

For each unpaid invoice, user clicks on download button.

### Identified Packages

User logs into intranet system: No package found (prompt rewritten).

User logs into online account using email and password.

User clicks on a user interface option for 'unpaid invoices': The script generation engine finds a stored package related to unpaid invoice actions.

User sees a list of unpaid invoices: The script generation engine finds a stored package related to showing a list of unpaid invoices.

For each unpaid invoice, user clicks on a download button in the user interface: The script generation engine finds a stored package related to downloading unpaid invoices.

### Input and Output Parameters

User logs into their company account using email and password.

Input: Username, Password: This may be an example of an input parameter for a script to automatically pay (or perform some other act if the invoice is for the user to pay).

Output: Cookies may be generated for the input parameters related to logging in.

User clicks on 'unpaid invoices'.

Input: Cookies may be generated for the user action of clicking (selecting) a feature such as viewing unpaid invoices.

User sees a list of unpaid invoices.

Input: Cookies may be generated related to listing unpaid invoices.

Output: An output parameter may be generated to display a list of unpaid invoices.

For each unpaid invoice, user clicks on download button.

Input: An input parameter may be generated to display a list of unpaid invoices for each invoice selected, along with cookies related to the action.

Output: An output parameter may be generated to display a list of bytes representing a file per unpaid invoice in response to the input parameter for displaying selected unpaid invoices.

### Conclusion

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer program product for automated generation of scripts, the computer program product comprising a computer readable storage medium having program instructions embodied therewith, wherein an execution of the program instructions cause a processor to:
receive, by a script generation engine, a user input prompt for a task and packages associated with the task, via a user interface;
parse, by a machine learning engine, the prompt into words representing a process associated with the task;
determine by the machine learning engine, context from the words related to the task and associate the context with the packages;
identify, by the machine learning engine, one or more sections of packages with context that are dynamic values within the process as potential variables;
query, by the script generation engine, a retrieval of stored packages associated with the task;
replace, by the machine learning engine, the dynamic values with a variable; and
generate, by the script generation engine, a script configured to perform the task, wherein the script includes the variable as a placeholder for a user entry of the dynamic values.

2. The computer program product of claim 1, wherein the execution of the program instructions further causes the processor to, upon a determination that none of the stored packages include the words related to the task, prompt a user to provide an additional context for the task.

3. The computer program product of claim 2, wherein the execution of the program instructions further causes the processor to add the additional context to the query for retrieval of stored packages.

4. The computer program product of claim 1, wherein the user input prompt includes a description of steps related to the task.

5. The computer program product of claim 4, wherein the execution of the program instructions further causes the processor to break down the description of steps into individual steps, by the machine learning engine.

6. The computer program product of claim 1, wherein the execution of the program instructions further causes the processor to:
identify, by the script generation engine, input and output parameters from the retrieved stored packages that include the process associated with the task; and
generate the script using the input and output parameters from the retrieved stored packages.

7. The computer program product of claim 1, wherein the execution of the program instructions further causes the processor to include a description of the variable in the script.

8. A computer implemented method for automated generation of scripts, comprising:
receiving, by a script generation engine, a user input prompt for a task and packages associated with the task, via a user interface;
parsing, by a machine learning engine, the prompt into words representing a process associated with the task;
determining by the machine learning engine, context from the words related to the task and associate the context with the packages;
identifying, by the machine learning engine, one or more sections of packages with context that are dynamic values within the process as potential variables;
querying, by the script generation engine, a retrieval of stored packages associated with the task;
replacing, by the machine learning engine, the dynamic values with a variable; and
generating, by the script generation engine, a script configured to perform the task, wherein the script includes the variable as a placeholder for a user entry of the dynamic values.

9. The method of claim 8, further comprising, upon a determination that none of the stored packages include the words related to the task, prompting a user to provide an additional context for the task.

10. The method of claim 9, further comprising adding the additional context to the query for retrieval of stored packages.

11. The method of claim 8, wherein the user input prompt includes a description of steps related to the task.

12. The method of claim 11, further comprising breaking down the description of steps into individual steps, by the machine learning engine.

13. The method of claim 8, further comprising:
identifying, by the script generation engine, input and output parameters from the retrieved stored packages that include the process associated with the task; and
generating the script using the input and output parameters from the retrieved stored packages.

14. The method of claim 8, further comprising including a description of the variable in the script.

15. A computing device, comprising:
a processor operating a user interface; and
a memory coupled to the processor, the memory storing instructions to cause the processor to perform acts comprising:
receiving, by a script generation engine, a user input prompt for a task and packages associated with the task, via a user interface;
parsing, by a machine learning engine, the prompt into words representing a process associated with the task;
determining by the machine learning engine, context from the words related to the task and associate the context with the packages;
identifying, by the machine learning engine, one or more sections of packages with context that are dynamic values within the process as potential variables;
querying, by the script generation engine, a retrieval of stored packages associated with the task;
replacing, by the machine learning engine, the dynamic values with a variable; and
generating, by the script generation engine, a script configured to perform the task, wherein the script includes the variable as a placeholder for a user entry of the dynamic values.

16. The computing device of claim 15, wherein the instructions cause the processor to perform further acts comprising, upon a determination that none of the stored packages include the words related to the task, prompting a user to provide an additional context for the task.

17. The computing device of claim 16, wherein the instructions cause the processor to perform further acts comprising adding the additional context to the query for retrieval of stored data packages.

18. The computing device of claim 15, wherein the user input prompt includes a description of steps related to the task.

19. The computing device of claim 18, wherein the instructions cause the processor to perform further acts comprising breaking down the description of steps into individual steps, by the machine learning engine.

20. The computing device of claim 15, wherein the instructions cause the processor to perform further acts comprising:
identifying, by the script generation engine, input and output parameters from the retrieved stored packages that include the process associated with the task; and
generating the script using the input and output parameters from the retrieved stored packages.
